(19) United States
(12) Patent Application Publication
(10) Pub. No.: US 2019/0297910 A1
(43) Pub. Date: Oct. 3, 2019

(54) SYSTEMS AND APPROACHES FOR ROASTING INFUSED COFFEE BEANS

(71) Applicant: Michael Tuttle, Anchorage, AK (US)

(72) Inventor: Michael Tuttle, Anchorage, AK (US)

(21) Appl. No.: 16/363,231

(22) Filed: Mar. 25, 2019

Related U.S. Application Data
(60) Provisional application No. 62/648,608, filed on Mar. 27, 2018.

(51) Int. Cl. A23F 5/04; A23F 5/14

(52) U.S. Cl. CPC A23F 5/04; A23N 12/125; A23F 5/14

(57) ABSTRACT

Systems and approaches for roasting coffee beans are described whereby a roasting apparatus is provided that includes a container and a heat source. The roasting apparatus is heated to a first temperature. Coffee beans are placed in the container, and at least one variable is measured while the coffee beans are in the container. Upon the at least one variable reaching at least one threshold value, a first quantity of a high-fat solution is added to the container, thereby coming into contact with the coffee beans. In some examples, the high-fat solution may be in the form of a clarified butter, and in particular, ghee butter. The coffee beans are then removed from the heat source to cool.

### CROSS REFERENCE TO RELATED APPLICATIONS

This application claims the benefit of U.S. Provisional Application No. 62/648,608, filed on Mar. 27, 2018, the entirety of which is herein expressly incorporated by reference.

### FIELD OF THE DISCLOSURE

The present disclosure generally relates to coffee beans and, more particularly, to processes for roasting coffee beans with a high-fat additive.

### BACKGROUND

Coffee is consumed by a substantial population for its stimulating and/or energizing effects. A current trend in some circles is to add a high-fat additive, such as, for example, butter, to coffee due to the potential of a variety of benefits. This process, however, can add additional time-consuming and costly steps to the beverage-making process and typically require additional dishes and/or appliances. In one example, a user brews the coffee and subsequently pours the coffee into a blender along with a desired amount of butter to mix the ingredients together.

However, the additional time and effort required of such steps may deter people from partaking in this combination. Further, a consumer may be unaware of proper quantities of coffee and/or high-fat solution to use when preparing their beverage, and thus may become dissatisfied with the taste and flavor profile of the coffee if it is not properly prepared. As a result, the consumer may be dissuaded from enjoying the beverage in the future.

### SUMMARY

One aspect of the present disclosure provides an approach for roasting coffee beans whereby a roasting apparatus is provided that includes a container and a heat source. The roasting apparatus is heated to a first temperature. Coffee beans are placed in the container, and at least one variable is measured while the coffee beans are in the container. Upon the at least one variable reaching at least one threshold value, a first quantity of a high-fat solution is added to the container, thereby coming into contact with the coffee beans. In some examples, the high-fat solution may be in the form of a clarified butter (such as ghee butter), avocado oil, coconut oil, MCT oil, or any other type of fatty oil. Other examples are possible. The coffee beans are then removed from the heat source to cool.

In some examples, the at least one variable may be a bean temperature value, a roast time, an audible indicator, or a color indicator. In examples where the at least one variable is a bean temperature value, the at least one threshold value may be a temperature between approximately 200° F. and approximately 500° F. Other examples of suitable temperature ranges are possible.

In examples where the at least one variable includes a roast time, the at least one threshold value may be in the form of an elapsed time that the coffee beans have been in the container and subjected to the heat source. In examples where the at least one variable includes an audible indicator, the at least one threshold value may be in the form of an audible noise (e.g., a pop and/or a cracking sound) generated by the coffee beans. Further, in examples where the at least one variable includes a color indicator, the at least one threshold value may be in the form of a change in color of the coffee beans.

In some approaches, upon the at least one variable reaching any number of additional thresholds, additional quantities of high-fat solution may be added to the container as desired.

A second aspect of the present disclosure provides a process of roasting coffee beans that includes heating a roasting apparatus having a container to a temperature between approximately 200° F. and approximately 600° F., preferably between approximately 275° F. and approximately 400° F., and more preferably between approximately 325° F. and approximately 375° F. A quantity of coffee beans is added to the container, and the coffee beans are allowed to reach a temperature between approximately 200° F. and approximately 500° F., preferably between approximately 275° F. and approximately 400° F., and more preferably between approximately 325° F. and approximately 375° F. A first quantity of high-fat solution is added to the container. Upon the coffee beans generating a first audible noise, a second quantity of high-fat solution is added to the container. Upon the coffee beans changing to a first color, a third quantity of high-fat solution is added to the container. Upon the coffee beans generating a second audible noise, a fourth quantity of high-fat solution is added to the container. Upon the coffee beans changing to a second color, a fifth quantity of high-fat solution is added to the container. The beans are then removed from heat to be cooled.

In some approaches, the first quantity of high-fat solution comprises between approximately 1.75 oz and approximately 2.25 oz. Other examples are possible. In some aspects, the second quantity of high-fat solution comprises between approximately 3.75 oz and approximately 4.25 oz. Other examples are possible. In some forms, the third quantity of high-fat solution comprises between approximately 2.75 oz and approximately 3.25 oz. Other examples are possible. Further, in some examples, the fourth quantity of high-fat solution comprises between approximately 1.75 oz and approximately 2.25 oz. Other examples are possible.

A third aspect of the present disclosure provides an infused coffee bean including a coffee bean that is subjected to a roasting process. The coffee bean is infused with a high-fat solution during the roasting process such that the high-fat solution at least partially penetrates an outer shell of the coffee bean.

### BRIEF DESCRIPTION OF THE DRAWINGS

The above needs are at least partially met through provision of the systems and approaches for roasting infused coffee beans described in the following detailed description, particularly when studied in conjunction with the drawings, wherein:

FIG. 1 illustrates a schematic view of an example system for roasting coffee beans in accordance with various embodiments;

FIG. 2 illustrates a flow chart of an approach for roasting coffee beans in accordance with various embodiments; and

FIG. 3 illustrates a flow chart of an approach for roasting coffee beans in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

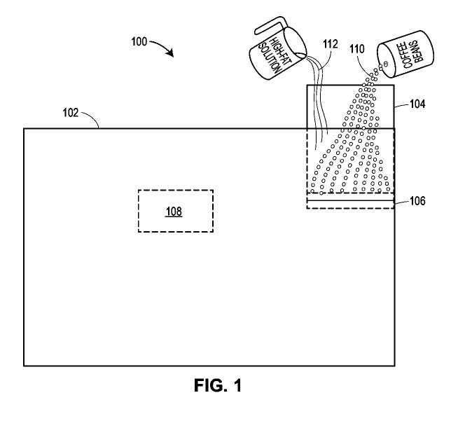

Generally speaking, pursuant to these various embodiments, systems and approaches for roasting infused coffee beans are provided. Generally, during the roasting process, a high-fat solution such as, for example, clarified butter (such as ghee butter), avocado oil, coconut oil, MCT oil, or any other type of fatty oil, is added to the beans. This process allows the high-fat solution to penetrate the outer shell of the coffee bean, thereby imparting flavors and healthy fats into the beans themselves. Turning to FIG. 1, a system 100 for roasting infused coffee beans includes a roaster 102 having a container 104 and a heat source 106. In some examples, the roaster 102 may include additional components such as, for example, a computing device 108 having any number of components (e.g., processors, controllers, and/or sensors) disposed therein and/or coupled thereto. The roaster 102 may be any type of suitable roasting apparatus such as, for example, a hot air roaster, a centrifugal roaster, a tangential roaster, a drum roaster, and/or a packed bed roaster. For example, the roaster 102 may be one of a Sonofresco Two Pound Coffee Roaster, a Coffee Crafters Artisan 9 roaster or a Coffee Crafters Artisan 2.5 roaster. Other examples are possible. The roaster 102 may operate in a continuous mode, a batch mode, or any desired combination of these modes.

The container 104 may be any type of hollow, shell-like receptacle dimensioned to receive green (i.e., non-roasted) coffee beans 110 as well as a high-fat solution 112. Specifically, the container 104 may be a drum constructed from metals, polymers, glass, and/or any other suitable material. In some examples, the container 104 may accommodate manual addition of the coffee beans 110 and/or the high-fat solution 112. In other examples, the container 104 may accommodate a hopper (not shown) or other device that may automatically add desired quantities of the coffee beans 110 and/or the high-fat solution 112. Such operation may be controlled by the controller 108.

The heat source 106 may be any type of suitable heat source that provides heat to the container 104. In some examples, the heat source 106 may be an electrical heat source, a natural or petroleum gas heat source, and/or a wood heat source, and may include any number of additional components necessary to provide heat to the container 104.

The coffee beans 110 may be any unroasted (i.e., “green”) bean. These beans may be processed in any number of ways, such as, for example, natural processing, washing, or semi-washing. Other examples are possible.

The high-fat solution 112 may be any solution and/or composition containing a high quantity of fat. In one example, the high-fat solution 112 may be a clarified butter, such as, for example, ghee butter, which advantageously has an appealing, rich, nutty flavor profile. Further, ghee butter, when consumed in appropriate quantities, may contain beneficial proteins and nutrients. Additionally, by using ghee butter, the final product (i.e., infused roasted coffee beans) is shelf stable due to the extraction of milk solids. The high-fat solution 112 may or may not be pre-heated prior to adding it to the container 104. Generally, for every 6-24 oz of coffee beans 110, approximately 0.01 oz to approximately 1 oz of high-fat solution 112 is added to the container, depending on the desired effect. Using too much high-fat solution may exceed the fat ratio delivered to the body. In a preferred embodiment, approximately 0.3 oz of high-fat solution 112 is added for every 12 oz of coffee beans 110, which may result in approximately 1 tsp fat per individual serving of coffee. Other examples of high-fat solutions 112 can include, but are not limited to, avocado oil, coconut oil, and/or MCT oil, or any combination thereof. Other examples are possible.

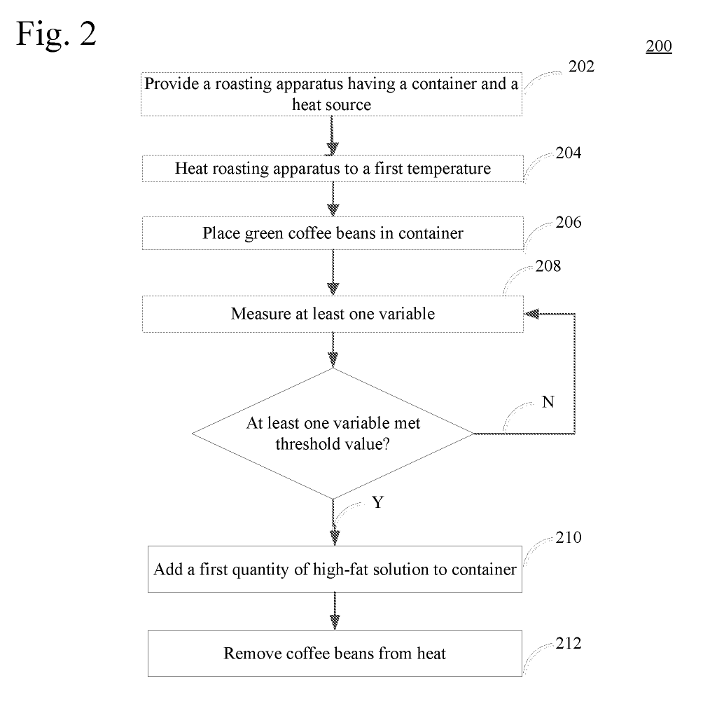

Turning to FIG. 2, one approach 200 for roasting coffee beans includes providing 202 a roasting apparatus (e.g., roaster 102 of FIG. 1) having a container and a heat source. At a step 204, the roasting apparatus is heated to a first temperature. In some examples, the first temperature may be between approximately 200° F. and approximately 600° F., preferably between approximately 275° F. and approximately 400° F., and more preferably between approximately 325° F. and approximately 375° F., and more preferably, approximately 350° F. Other examples of suitable temperatures and/or ranges are possible.

Next, at a step 206, the green coffee beans (e.g., beans 110 in FIG. 1) are placed in the container and thus begin increasing in temperature and begin the roasting process. Any suitable quantity of coffee beans may be added to the container during this step. For example, approximately 10 lb of beans may be added to the container. In some forms, the coffee beans may be manually added to the container, and in other forms, the coffee beans may be automatically dispensed into the container (e.g., via a hopper or similar system). During this process, and at step 208, at least one variable is measured while the beans are in the container. These measurements may be taken continuously and/or periodically by a user, a sensing device, and/or via any other suitable approach.

The step 208 may involve measuring any number of variables. For example, any combination of a bean temperature, a roast or elapsed time, an audible indicator, and/or a color indicator may be measured. Any or all of these values may be measured using any suitable device, and in some examples, may be measured via a visual and/or an auditory inspection. As a non-limiting example, to measure the bean temperature, a thermometer may be disposed in the container and may measure and display the current temperature of the beans. Alternatively, a sensor may be disposed in the container and be coupled to the computing device to provide automated measurements thereto. As another non-limiting example, to measure the roast or elapsed time, a timer may be used that is activated upon placing the beans into the container. This timer may or may not be coupled to the computing device to provide automated measurements.

As yet another non-limiting example, to measure the audible indicator, a user may listen for a popping or cracking sounds generated by the coffee beans. Such a sound may be indicative of the threshold being met. Alternatively, a sensing device such as a microphone may be used and be coupled to the computing device to automatically determine when the audible indicator occurs.

Still further, as another non-limiting example, to measure the color indicator, a user may visually inspect the beans to determine whether a color change (e.g., whether the beans have darkened to a desired hue) has occurred. Such a change in color may be indicative of the threshold being met. Alternatively, a sensing device such as a colorimeter may be used and be coupled to the computing device to automatically determine when the color indicator occurs.

When the at least one variable reaches at least one threshold value, at step 210, a first quantity of a high-fat solution (e.g., clarified butter (such as ghee butter), avocado oil, coconut oil, MCT oil, or any other type of fatty oil) is added to the container. In some forms, the high-fat solution may be manually added to the container, and in other forms, the high-fat solution may be automatically dispensed into the container (e.g., via a hopper or similar system). For example, between approximately 1.5 oz and approximately 2.5 oz, and preferably approximately 2.0 oz of the high-fat solution may be added to the container. Other examples are possible.

At this point, the coffee beans are then allowed to soak in the solution for a specified period of time (e.g., between approximately 1 and approximately 60 minutes). By allowing the coffee beans to soak in the high-fat solution, the high-fat solution may penetrate the bean due to the heat, and thus may impart more flavors into the coffee bean whilst avoiding being overpowering.

During this time, the at least one variable may continue to be measured, and upon reaching any number of additional thresholds (e.g., second through tenth thresholds); additional quantities of the high-fat solution may be added to the container. In some of these examples, different ones of the at least one variable may be used as an indicator for the different thresholds. As a non-limiting example, an audible indicator may be used to determine whether the second threshold has been met, while a color indicator may be used to determine whether the third threshold has been met. Other examples and/or combinations are possible. Varying amounts of high-fat solution may be added at different times during the roasting process, or alternatively, a constant amount of high-fat solution may be added at each additional desired time.

At a step 212, the coffee beans are removed from the heat source to cool and/or oxidize and to allow for further processing (e.g., packaging, grinding, and the like). In some examples, the coffee beans may cool and/or oxidize between approximately one hour and approximately 24 hours prior to additional processing to ensure the now-infused roasted coffee beans do not stick to each other.

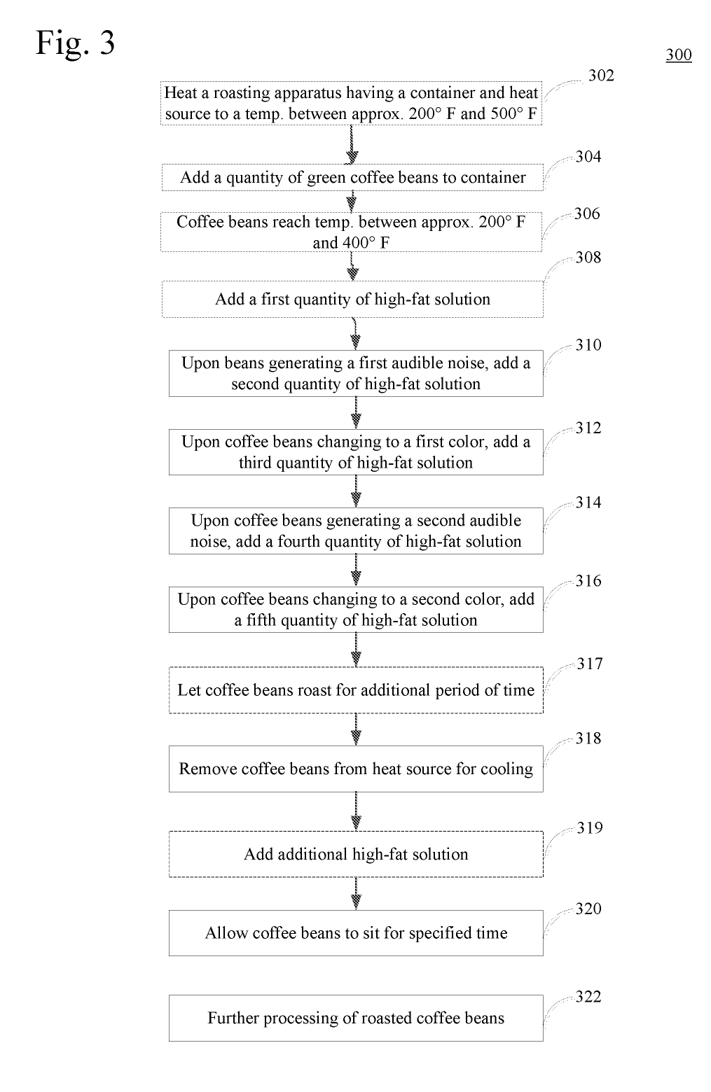

FIG. 3 illustrates a detailed approach 300 for roasting coffee beans that uses specific measured variables to determine a number of thresholds. These thresholds may correspond to any combination of the thresholds described with regard to FIG. 2. At a step 302, a roasting apparatus having a container is heated to a temperature between approximately 200° F. and approximately 600° F., preferably between approximately 275° F. and approximately 400° F., and more preferably between approximately 325° F. and approximately 375° F. At a step 304, a quantity (e.g., approximately 10 pounds) of green coffee beans are added to the container. At a step 306, the coffee beans reach a temperature between approximately 200° F. and approximately 500° F., preferably between approximately 275° F. and approximately 400° F., and more preferably between approximately 325° F. and approximately 375° F.

At a step 308, a first quantity of high-fat solution (e.g., ghee butter) is added to the container. In some examples, approximately 2.0 oz of high-fat solution is added. Other examples are possible. At a step 310, upon the coffee beans generating a first audible noise (e.g., a popping or a cracking sound), a second quantity of high-fat solution is added to the container and is mixed with the coffee beans. This process can take between approximately two and approximately four minutes. Other examples are possible. In some examples, approximately 4.0 oz of high-fat solution is added at this stage. Other examples are possible.

At a step 312, upon the coffee beans changing to a first color, a third quantity of high-fat solution is added to the container. For example, upon the color of the coffee beans turning to a light brown shade, the high-fat solution may then be added. This process can take between approximately six and approximately eight minutes. Other examples are possible. In some examples, approximately 3.0 oz of high-fat solution is added at this stage. Other examples are possible.

At a step 314, upon the coffee bean generating a second audible noise (e.g., a popping or a cracking sound), a fourth quantity of high-fat solution is added to the container. This process can take between approximately eight and approximately 10 minutes. During this step, the temperature of the beans should reach approximately 400° F., and the bean color should be a medium to medium-dark brown. In some examples, depending on the desired roast of the beans, the bean color may be light, medium, or dark-colored. Either or any of these thresholds may be used to determine when to add the fourth quantity of high-fat solution. In some forms, approximately 2.0 oz of high-fat solution is added. Other examples are possible.

At a step 316, upon the coffee beans experiencing an additional color change, a fifth quantity of high-fat solution is added to the container. For example, upon the color of the coffee beans turning to a dark brown shade, the high-fat solution may then be added. This process can take between approximately 10 and approximately 15 minutes, more preferably approximately 13 minutes. Other examples are possible. In some examples, approximately 2.0 oz of high-fat solution is added at this stage. Other examples are possible.

At this time, the coffee beans may optionally sit and continue to roast for approximately five minutes (step 317) or the coffee beans may be removed from the heat source to be cooled (step 318). At an optional step 319, additional high-fat solution may be poured over the coffee beans as desired to impart additional flavor.

At a step 320, the coffee beans sit for a specified time. For example, the coffee beans may sit for a time between approximately one and approximately 30 hours, and more preferably, between approximately two and approximately four hours. Other suitable time frames are possible. At a step 322, the now-roasted-and-infused coffee beans proceed to further processing (e.g., bagging, grinding, and the like).

So configured, infused roasted coffee beans are provided which may be sold to consumers in whole and/or ground bean form. By infusing the beans during the roasting process, the user is still saved a potentially time-consuming and costly step. The user also needn't be concerned about adding correct quantities of high fat solution such as clarified butter, thus avoiding the potential for adding too much or too little prior to drinking the coffee. Additionally, the use of clarified butter allows the roasted coffee beans to be shelf stable due to the milk solids being removed from the solution.

Unless specified otherwise, any of the feature or characteristics of any one of the embodiments of the systems and approaches for roasting infused coffee beans disclosed herein may be combined with the features or characteristics of any other embodiments.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A method of roasting coffee beans, the method comprising:
providing a roasting apparatus having a container and a heat source;
heating the roasting apparatus to a first temperature;
placing coffee beans in the container;
measuring at least one variable while the coffee beans are in the container;
upon the at least one variable reaching at least one threshold value, adding a first quantity of a high-fat solution to the container; and
removing the coffee beans from the heat source.

2. The method of claim 1, wherein the at least one variable comprises at least one of a bean temperature, a roast time, an audible indicator, or a color indicator.

3. The method of claim 1, wherein the at least one variable comprises a bean temperature value, wherein the at least one threshold value comprises a temperature between approximately 200° F. and approximately 500° F.

4. The method of claim 1, wherein the at least one variable comprises a roast time, wherein the at least one threshold value comprises an elapsed time the coffee beans have been in the container.

5. The method of claim 1, wherein the at least one variable comprises an audible indicator, wherein the at least one threshold value comprises an audible noise generated by the coffee beans.

6. The method of claim 1, wherein the at least one variable comprises a color indicator, wherein the at least one threshold value comprises a change in color of the coffee beans.

7. The method of claim 1, further comprising:
upon the at least one variable reaching a plurality of additional thresholds, adding a quantity of high-fat solution to the container.

8. The method of claim 1, wherein the high-fat solution comprises at least one of:
a clarified butter,
avocado oil,
coconut oil, or
MCT oil.

9. The method of claim 8, wherein the clarified butter comprises a ghee butter.

10. A method of roasting coffee beans, the method comprising:
heating a roasting apparatus having a container to a temperature between approximately 200° F. and approximately 600° F.;
adding a quantity of coffee beans to the container;
allowing the coffee beans to reach a temperature between approximately 200° F. and approximately 500° F.;
adding a first quantity of a high-fat solution to the container;
upon the coffee beans generating a first audible noise, adding a second quantity of high-fat solution to the container;
upon the coffee beans changing to a first color, adding a third quantity of high-fat solution to the container;
upon the coffee beans generating a second audible noise, adding a fourth quantity of high-fat solution to the container;
upon the coffee beans changing to a second color, adding a fifth quantity of high-fat solution to the container; and
cooling the coffee beans.

11. The method of claim 10, further comprising upon the coffee beans changing to a second color, adding a sixth quantity of high-fat solution to the container.

12. The method of claim 10, wherein the high-fat solution comprises at least one of:
a clarified butter,
avocado oil,
coconut oil, or
MCT oil.

13. The method of claim 10, wherein the clarified butter comprises a ghee butter.

14. The method of claim 10, wherein the first quantity of high-fat solution comprises between approximately 1.75 oz and approximately 2.25 oz.

15. The method of claim 10, wherein the second quantity of high-fat solution comprises between approximately 3.75 oz and approximately 4.25 oz.

16. The method of claim 10, wherein the third quantity of high-fat solution comprises between approximately 2.75 oz and approximately 3.25 oz.

17. The method of claim 10, wherein the fourth quantity of high-fat solution comprises between approximately 1.75 oz and approximately 2.25 oz.

18. An infused coffee bean comprising:
a coffee bean subjected to a roasting process, the coffee bean being infused with a high-fat solution during the roasting process such that the solution at least partially penetrates an outer shell of the coffee bean.

19. The infused coffee bean of claim 18, wherein the high-fat solution comprises at least one of:
a clarified butter,
avocado oil,
coconut oil, or
MCT oil.

20. The infused coffee bean of claim 19, wherein the clarified butter comprises a ghee butter.
